(19) United States
(12) Patent Application Publication
(10) Pub. No.: US 2015/0031781 A1
(43) Pub. Date: Jan. 29, 2015

(54) ADDITIVE FOR ADJUSTING THE GLASS TRANSITION TEMPERATURE OF VISCO-ELASTIC POLYURETHANE SOFT FOAMS

(71) Applicant: Evonik Industries AG, Essen (DE)

(72) Inventors: Ruediger Landers, Essen (DE); Roland Hubel, Essen (DE)

(73) Assignee: EVONIK INDUSTRIES AG, Essen (DE)

(21) Appl. No.: 14/383,337

(22) PCT Filed: Feb. 8, 2013
(86) PCT No.: PCT/EP2013/052516

§ 371 Date: Sep. 5, 2014

(30) Foreign Application Priority Data
Mar. 8, 2012 (DE) 10 2012 203 639.3

(51) Int. Cl. C08J 9/00; C08K 5/098; C08G 18/76; C08G 18/08; C08G 18/48

(52) U.S. Cl. CPC C08J 9/0023; C08G 18/14; C08G 18/4804; C08G 18/7621; C08K 5/098; C08J 2375/08
USPC 521/117; 521/174

(57) ABSTRACT

The present invention is directed to the use of a disalt of malic acid in the production of a polyurethane foam to lower the glass transition temperature of the polyurethane foam obtained, wherein the disalt of malic acid is added to the reaction mixture comprising at least a polyol component, an isocyanate component, a catalyst to catalyse urethane or isocyanurate bond formation, an optional blowing agent and optionally further additives, and also to a polyurethane foam having a glass transition temperature of −20° C. to 15° C., which polyurethane foam is characterized in that it comprises disalts of malic acid or reaction products thereof with an isocyanate component, wherein the fraction accounted for by the disalts and the reaction products thereof with an isocyanate component is below 0.08 wt % based on the polyurethane foam.

The present application for a patent relates to the use of a disalt of malic acid in the production of a polyurethane foam to lower the glass transition temperature of the polyurethane foam obtained, wherein the disalt of malic acid is added to the reaction mixture comprising at least a polyol component, an isocyanate component, a catalyst to catalyse urethane or isocyanurate bond formation, an optional blowing agent and optionally further additives, and also to the polyurethane foams thus obtained.

### RELATED ART

Flexible polyurethane foams are currently widely used for producing mattresses, upholstered furniture or car seats. They are obtained by reacting isocyanates with polyols and water. Additives used typically include catalysts (amine catalysts and tin catalysts) and/or foam stabilizers. Physical blowing agents can also be used in addition to the chemical blowing agent water.

It is known to use hydroxy carboxylic acids or salts thereof as additives in the production of polyurethane foams.

EP 0 075 424 describes the use of a composition to be added to polyurethane foams to supposedly help avoid the formation of smoke and toxic gases in the combustion of polyurethane foams, wherein said composition includes tartaric or malic acid as char-stabilizing component. The additive can be added in the course of foam production, but preferably the final polyurethane foam is impregnated with the composition. The preferred amount of malic acid used is stated to be 5%, based on the polyurethane foam.

JP 63301293 describes the production of polyurethane foams in the presence of citric acid. The citric acid is added to avoid the material decomposing/rotting.

EP 0 475 242 describes a process for producing soft flexible polyurethane foams wherein the use of physical blowing agents, especially chlorofluorocarbons and methylene chloride, is to be avoided or at least appreciably reduced. This object is achieved therein by the use of 0.1 to 1 part by weight of alkali or alkaline earth metal salts of a hydroxy carboxylic acid per 100 parts by weight of polyol. Especially malic acid, tartaric acid, citric acid and lactic acid are recited as hydroxy carboxylic acids.

Viscoelastic foams are a particular segment of flexible polyurethane foams. The characteristic properties of viscoelastic flexible polyurethane foams are a retarded return to the original shape after deformation and a low rebound resilience. This return to the original shape takes several seconds for a deformed specimen of the foam. Rebound resilience is less than 10%, measured in the falling ball test of DIN EN ISO 8307. Standard flexible polyurethane foams, by contrast, would return to the initial shape within periods distinctly below one second and would have a rebound resilience of about 30 to 60%.

These properties of viscoelastic flexible polyurethane foams are achieved through an unusually high glass transition temperature. It is between −20 and +15° C. in viscoelastic foams. The glass transition temperature of standard flexible polyurethane foams, by contrast, is generally below −35° C. Average glass transition temperature can be measured using dynamic mechanical analysis (DMA) (DIN 53513) or using differential scanning calorimetry (DSC) (ISO 11357-2). What is measured is strictly speaking a glass transition range which extends over a temperature range. The glass transition temperatures referred to hereinbelow are average values. Owing to the high glass transition temperature of viscoelastic flexible foams, some network segments in the polyurethane network are still frozen, and restricted in their mobility, at room temperature. This affects the resilience of the entire polyurethane network and elicits a time-retarded behaviour. This mechanical behaviour is advantageous for specific applications in the sector of comfort foams. It is particularly for mattresses in hospitals and for pillows that the use of viscoelastic flexible polyurethane foams is popular, since the patient's bodyweight is supported by a comparatively large area and hence the occurrence of pressure sores is reduced.

Polyether polyol mixtures used for manufacturing viscoelastic polyurethane foams often include two or more polyols. And at least one of these polyols has a relatively high OH number (>100 mg KOH/g). This raises the density of network nodes and shifts the glass transition temperature in the direction of higher values. The mechanical properties desired for the foam then have to be adjusted concurrently by lowering the index or using monools. Details are apparent from the literature, including WO 01/57104A2; DE 3942330A2; S. Hager, R. Skorpenske, S. Triouleyre, F. Joulak, “New Technology for Viscoelastic Foam”, Journal of Cellular Plastics, Volume 37—September/October 2001 p. 377, and S. Kintrup, J. P. Treboux, H. Mispreuve, “Low Resilience—High Performance Recent Advances in Viscoelastic Flexible Slabstock Foam”, Proceedings of the Polyurethanes Conference, 2000, October 8-11, Boston, Mass.

The mechanical properties of such viscoelastic flexible foams do depend on the ambient temperature. At high ambient temperatures (>30° C.) the foam becomes very soft and the viscoelastic effect is lost. The reason is that then almost all network segments are mobile. At low temperatures (<15° C.) the foam becomes hard and too viscoelastic (no or extremely slow recovery from deformation). The reason is that then too many chain segments are frozen. Modulating the manufacturing formulations of viscoelastic foams to match the climate characteristics of the particular market is accordingly very important. The viscoelastic properties are varied by shifting the glass transition temperature. Minimal changes in the glass transition temperature have a direct influence on the mechanical properties of the foam formed. The customary way to modify the glass transition temperature is either to vary the crosslink density of the polyurethane network, or to vary the chemical composition of network segments. The former is easily done in the case of flexible polyurethane foams by varying the ratio of isocyanate groups to isocyanate-consuming groups (the “index”). It is further possible to take advantage of the functionality of various multifunctional compounds to shift the glass transition temperature by adding them. Crosslinking components (functionality>2) raise the glass transition temperature, while components having a functionality<2 lower the crosslink density.

Chemical modifications to network structure concern particularly the chain length of the polyols and monomers used. These modifications all have the disadvantage that relatively large changes have to be made to the formulations. But this will change many other parameters besides the glass transition temperature, such as rise times in foaming, air permeability, settling or the cell structure. This means that making such changes to the crosslink density becomes a complex undertaking.

The problem addressed by the present invention was therefore that of providing an additive which, added even in a relatively small amount, is effective in shifting the glass transition temperature in the desired manner. Its effectiveness in this should preferably be distinctly greater than that of the customarily used crosslinkers or low-functional admixtures.

It was found that, surprisingly, the problem is solved by the use of disalts of malic acid in the production of polyurethane foams.

The present invention accordingly provides a process for producing a polyurethane foam having a lowered glass transition temperature by reacting a polyol component with an isocyanate component, which process is characterized in that the reaction takes place in the presence of a disalt of malic acid, and/or for use of a disalt of malic acid in the production of a polyurethane foam to lower the glass transition temperature of the polyurethane foam obtained, wherein the disalt of malic acid is added to the reaction mixture comprising at least a polyol component, an isocyanate component, a catalyst to catalyse urethane or isocyanurate bond formation, an optional blowing agent and optionally further additives.

The present invention likewise provides a polyurethane foam having a glass transition temperature of −20° C. to 15° C., characterized in that the polyurethane foam comprises disalts of malic acid or reaction products thereof with an isocyanate component, wherein the fraction accounted for by the disalts and the reaction products thereof with an isocyanate component is below (in sum total) 0.08 wt % based on the polyurethane foam.

Compared with a monofunctional comparator (n-butanol), for which a lowering of 0.3° C. was observed on being used at 0.1 part by mass per 100 parts by mass of polyol component, the use of 0.12 part by mass of disodium malate per 100 parts by mass of polyol component was observed to lower the glass transition temperature by 5.5° C. Hence the disalts of malic acid have the advantage that even a very small amount of disalt can achieve a large shift in the glass transition temperature. Difunctional comparators (propylene glycol for example) only change the glass transition temperature minimally, if at all. Trifunctional, i.e. crosslinking substances (glycerol for example), render the polyurethane network less flexible and hence raise the glass transition temperature. Disalts of malic acid are therefore a very efficient and simple way to lower the glass transition temperature.

The disalts are generally readily soluble in water, so homogeneous solutions of salts of malic acid are simple to obtain. Solutions of this type can be used instead of the pure salts of malic acid, since solutions of this type are simpler to add to the reaction mixture and to mix in.

The polyurethane foam according to the invention has the advantage of having a rebound resilience of below 10% and of thus being useable as a viscoelastic polyurethane foam.

The subjects of the present invention will now be described by way of example without any intention to restrict the invention to these exemplary embodiments. Where ranges, general formulae or classes of compounds are referred to in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present invention, their content shall fully form part of the disclosure content of the present invention particularly in respect of the substantive matter in the context of which the document was cited. Percentages are by weight, unless otherwise stated. Average values referred to hereinbelow are weight averages, unless otherwise stated. Where parameters are referred to hereinbelow which were determined by measurement, the measurements were carried out at a temperature of 25° C. and a pressure of 101.325 Pa unless otherwise stated.

When a disalt of malic acid is used according to the present invention in the production of polyurethane foam, the disalt of malic acid is added to the reaction mixture comprising at least a polyol component, an isocyanate component, a catalyst to catalyse urethane or isocyanurate bond formation, an optional blowing agent and optionally further additives to lower the glass transition temperature of the polyurethane foam obtained.

Polyurethane foam (PU foam) refers in the context of the present invention to foam obtained as reaction product based on di- or polyfunctional isocyanates and polyols/compounds having isocyanate-reactive groups. In the course of the reaction to form the polymers polyurethane, further functional groups can also be formed, examples being allophanates, biurets, ureas or isocyanurates. Therefore, PU foams within the meaning of the present invention include polyisocyanurate foams (PIR foams) as well as polyurethane foams (PUR foams). Water can be used as blowing agent. Its use results in the formation of carbon dioxide and the corresponding amine which reacts with further isocyanate to form a urea group. The polyurethane foam may in this case also be constructed from a majority of urea groups as well as urethane groups. Viscoelastic flexible polyurethane foams are preferred polyurethane foams.

Malic acid in the context of the present application is to be understood as meaning hydroxysuccinic acid (also called hydroxybutanoic acid). Useful disalts of malic acid include the disalts of all isomeric forms of malic acid, i.e. the L-form or the D-form or any desired mixtures thereof. Preference is given to using the disalt of racemic hydroxysuccinic acid or the disalt of naturally occurring/biotechnologically produced L-hydroxysuccinic acid. It is more preferable for the malic acid disalt used to be the L-hydroxysuccinic acid disalt obtainable/obtained from renewable raw materials.

The salts of malic acid used are preferably the disalts wherein it is thus the case that the proton in each of the two acid groups is replaced by another cation. The cations in the malic acid salts used according to the present invention are preferably ammonium, alkali metal or alkaline earth metal cations. The cations in preferred salts of malic acid are ammonium, sodium and/or potassium ions. In the malic acid disalts used, the two cations can be of the same type or of a different type. Preference is given to using disalts of malic acid wherein the two cations are of the same type and more particularly both cations are sodium cations. It is therefore particularly preferable to use the disodium salt of malic acid.

It is particularly preferable for the malic acid salt used to be the disodium salts of hydroxysuccinic acid racemate or of L-hydroxysuccinic acid, preferably the disodium salts of L-hydroxysuccinic acid, preferably of an L-hydroxysuccinic acid obtainable/obtained from renewable raw materials.

The disalt of malic acid is preferably added in a concentration of above 0 to below 1 part by mass, preferably above 0 to below 0.5 part by mass, more preferably above 0 to below 0.1 part by mass and most preferably above 0.001 to below 0.09 part by mass per 100 parts by mass of polyol component.

It can be advantageous to add the disalt of malic acid to the reaction mixture as a preferably 1 to 50 wt % and more preferably 5 to 25 wt % solution of the disalt in preferably water, dipropylene glycol, propylene glycol, butyldiglycol, ethanol, isopropanol, ethylene glycol, diethylene glycol, polyether and/or polyol, preferably in water and/or dipropylene glycol. It is particularly preferable to use the disalt of malic acid as a 1 to 50 wt % and preferably 5 to 25 wt % solution of the disalt in a mixture comprising water and dipropylene glycol in a mass ratio of 0.5:1 to 1:0.5.

The polyurethane foam obtained using the disalt of malic acid according to the invention is obtainable in a conventional manner. A fundamental overview appears inter alia in G. Oertel, Polyurethane Handbook, 2nd edition, Hanser/Gardner Publications Inc., Cincinnati, Ohio, 1994, p. 177-247) and in D. Randall and S. Lee (eds.): “The Polyurethanes Book” J. Wiley, 1st edition, 2002.

### Polyol Component

Any polyol known from the prior art can be present in the reaction mixture. For the avoidance of doubt, it may be pointed here that for the purposes of the present application polyols are compounds that have two or more isocyanate-reactive hydrogen atoms, especially that is diols, triols, etc. It is preferably polyether polyols that are used as polyol component. Such polyether polyols are obtainable in a known manner, for example by anionic polymerization of alkylene oxides in the presence of, for example, alkali metal hydroxides or alkoxides as catalysts and in the presence of one or more than one starter molecule that contains 2 or more, especially 2 or 3, reactive hydrogen atoms in bonded form, or by cationic polymerization of alkylene oxides, preferably in the presence of Lewis acids as catalysts, for example antimony pentachloride or boron fluoride etherate, or by double metal cyanide catalysis. Suitable alkylene oxides preferably contain 2 to 4 carbon atoms in the alkylene moiety. Examples are tetrahydrofuran, 1,3-propylene oxide, 1,2-butylene oxide and 2,3-butylene oxide; use of ethylene oxide and/or 1,2-propylene oxide is preferred. The alkylene oxides can be used individually, alternatingly in succession or as mixtures. Useful starter molecules include especially water or 2- and 3-hydric alcohols, such as ethylene glycol, 1,2-propanediol, 1,3-propanediol, diethylene glycol, dipropylene glycol, glycerol, trimethylolpropane, etc. Polyols with multiple functionality, or polyfunctionality, such as sugars, can also be used as starters.

By way of polyol components, the reaction mixture preferably includes polyether polyols, preferably polyoxypropylene-polyoxyethylene polyols having a functionality (number of active hydrogen atoms, especially the number of OH groups) of 2 to 5 and number-averaged molecular weights in the range from 500 to 8000, preferably 800 to 3500. The polyol component preferably includes at least one polyol having a relatively high OH number of >100 mg KOH/g, determined as per DIN 53240.

Isocyanate Component Any isocyanate can be present in the reaction mixture especially any of the aliphatic, cycloaliphatic, araliphatic and preferably aromatic polyfunctional isocyanates known per se. Specific examples include alkylene diisocyanates having 4 to 12 carbon atoms in the alkylene moiety, such as 1,12-dodecane diisocyanate, 2-ethyftetramethylene 1,4-diisocyanate, 2-methylpentamethylene 1,5-diisocyanate, tetramethylene 1,4-diisocyanate and preferably hexamethylene 1,6-diisocyanate, cycloaliphatic diisocyanates, such as cyclohexane 1,3- and 1,4-diisocyanates and also any desired mixtures of these isomers, 1-isocyanato-3,3,5-trimethyl-5-isocyanatomethylcyclohexane (IPDI), 2,4- and 2,6-hexahydrotolylene diisocyanate and also the corresponding isomeric mixtures, 4,4′-, 2,2′- and 2,4′-dicyclohexylmethane diisocyanate and also the corresponding isomeric mixtures, and preferably aromatic di- and polyisocyanates, for example 2,4- and 2,6-tolylene diisocyanates and the corresponding isomeric mixtures, 4,4′-, 2,4′- and 2,2′-diphenylmethane diisocyanates and the corresponding isomeric mixtures, mixtures of 4,4′- and 2,2′-diphenylmethane diisocyanates, polyphenylpolymethylene polyisocyanates, mixtures of 4,4′-, 2,4′- and 2,2′-diphenylmethane diisocyanates and polyphenylpolymethylene polyisocyanates (crude MDI) and mixtures of crude MDI and tolylene diisocyanates. The organic di- and polyisocyanates can be used individually or in the form of mixtures thereof. Particular preference is given to mixtures of polyphenylpolymethylene polyisocyanate with diphenylmethane diisocyanate, and preferably the 2,4′-diphenylmethane diisocyanate content thereof is >30 wt % based on the isocyanate component.

It can also be advantageous for so-called modified polyfunctional isocyanates, i.e. products obtained by chemical conversion of organic di- and/or polyisocyanates, to be present in the isocyanate component. Di- and/or polyisocyanates containing ester, urea, biuret, allophanate, carbodiimide, isocyanurate, uretdione and/or urethane groups may be mentioned by way of example. Specific examples include modified 4,4′-diphenylmethane diisocyanate, modified 4,4′-and 2,4′-diphenylmethane diisocyanate mixtures, modified crude MDI or 2,4-/2,6-tolylene diisocyanate, organic, preferably aromatic polyisocyanates containing urethane groups and having NCO contents of 43 to 15 wt %, preferably of 31 to 21 wt %, based on the total weight, for example reaction products with low molecular weight diols, triols, dialkylene glycols, trialkylene glycols or polyoxyalkylene glycols with molecular weights up to 6000, especially with molecular weights up to 1500, wherein these di- or polyoxyalkylene glycols can be used individually or as mixtures. Examples are diethylene glycol, dipropylene glycol, polyoxyethylene, polyoxypropylene and polyoxypropylene polyoxyethene glycols, triols and/or tetrols. It is also possible to produce NCO-containing prepolymers having NCO contents of 25 to 3.5 wt %, preferably of 21 to 14 wt %, based on the total weight prepared from the hereinbelow described polyester and/or preferably polyether polyols and 4,4′-diphenylmethane diisocyanate, mixtures of 2,4′- and 4,4′-diphenylmethane diisocyanates, 2,4- and/or 2,6-tolylene diisocyanates or crude MDI. It will further be advantageous to use liquid polyisocyanates containing carbodiimide groups and/or isocyanurate rings and having NCO contents of 43 to 15, preferably 31 to 21, wt %, based on the total weight, for example on the basis of 4,4′-, 2,4′- and/or 2,2′-diphenylmethane diisocyanate and/or 2,4- and/or 2,6-tolylene diisocyanate.

The modified polyisocyanates may be mixed with each other or with unmodified organic polyisocyanates, for example 2,4′-diphenylmethane diisocyanate, 4,4′-diphenylmethane diisocyanate, crude MDI, 2,4- and/or 2,6-tolylene diisocyanate.

The following have proved particularly useful as organic polyisocyanates and therefore are preferable to use: tolylene diisocyanate, mixtures of diphenylmethane diisocyanate isomers, mixtures of diphenylmethane diisocyanate and polyphenylpolymethyl polyisocyanate or tolylene diisocyanate with diphenylmethane diisocyanate and/or polyphenylpolymethyl polyisocyanate or so-called prepolymers. It is preferable for substantially only tolylene diisocyanate to be present in the reaction mixture as isocyanate component, substantially here meaning a proportion of not less than 95 wt % based on the isocyanate component.

Particular preference for use as isocyanate component is given to mixtures of 2,4-tolylene diisocyanate with 2,6-tolylene diisocyanate where the 2,4-tolylene diisocyanate fraction is 80 wt %.

It is particularly preferable for the amount of isocyanates present as isocyanate component in the reaction mixture to be chosen such that the molar ratio of isocyanate groups present to active hydrogen atoms, especially OH groups, present in the reaction mixture is from 80 to 120:100.

### Catalyst to Catalyse Urethane or Isocyanurate Bond Formation

By way of catalyst to catalyse urethane or isocyanurate bond formation, the reaction mixture preferably includes one or more than one catalyst suitable for the reactions isocyanate-polyol and/or isocyanate-water and/or isocyanate trimerization. Suitable catalysts for the purposes of this invention are preferably catalysts that catalyse the gel reaction (isocyanate-polyol), the blowing reaction (isocyanate-water) and/or the di- or trimerization of the isocyanate.

Preferred catalyst quantities in the composition of the present invention depend on the type of catalyst and typically range from 0.05 to 5 pphp (=parts by mass per 100 parts by mass of polyol), preferably in the range from 0.05 to 0.5 pphp and most preferably in the range from 0.1 to 0.3 pphp, or 0.1 to 10 pphp for potassium salts.

Preferred catalysts for the gel reaction are selected from the group of organometallic compounds and metal salts of the following metals: tin, zinc, tungsten, iron, bismuth, titanium. Preference is given to using catalysts from the group of tin carboxylates, preferably tin 2-ethylhexanoate, tin isononanoate or tin ricinoleate. Preferably used catalysts are tin 2-ethylhexanoate and also tin compounds with wholly or partly covalently attached organic moieties, e.g. dibutyltin dilaurate.

Preferred catalysts for the blowing reaction are selected from the group of tertiary amines, preferably selected from the group containing or consisting of triethylenediamine, triethylamine, tetramethylbutanediamine, dimethylcyclohexylamine, bis(2-dimethylaminoethyl) ether, dimethylaminoethoxyethanol, bis(3-dimethylaminopropyl)amine, N,N,N′-trimethylaminoethylethanolamine, 1,2-dimethylimidazole, N-(3-aminopropyl)imidazole, 1-methylimidazole, N,N,N′,N′-tetramnethyl-4,4′-diaminodicyclohexylmethane, N, N-dimethylethanolamine, N,N-diethylethanolamine, 1,8-diazabicyclo-5,4,0-undecene, N, N,N′,N′-tetramethyl-1,3-propanediamine, N,N-dimethylcyclohexylamine, N,N,N′, N″, pentamethyldiethylenetriamine, N,N,N′,N″,N″′-pentamethyldipropylenetriamine, N, N′-dimethylpiperazine, N-methylmorpholine, N-ethylmorpholine, 2,2′-dimorpholinodiethyl ether, N,N-dimethylbenzylamine, N,N′,N″-tris(dimethylaminopropyl)hexahydrotriazine, N,N,N′,N′-tetramethyl-1,6-hexanediamine, tris(3-dimethylaminopropyl)amine, and tetramethylpropaneamine, and also the group of acid-blocked derivatives of tertiary amines. The amine used is preferably dimethylethanolamine, triethylenediamine or bis(2-dimethylaminoethyl) ether.

Very particularly suitable catalysts are the amines triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl) ether, tin compounds such as dibutyltin dilaurate and potassium salts such as potassium acetate and potassium 2-ethylhexanoate. Suitable catalysts are mentioned for example in EP 1985642, EP 1985644, EP 1977825, US 2008/0234402, EP 0656382 B1, US 2007/0282026 A1 and the patent documents cited therein.

### Optional Blowing Agents

By way of chemical blowing agent to produce hot-cure flexible polyurethane foams, the reaction mixture can include water which reacts with the isocyanate groups to release carbon dioxide. Water is preferably used in an amount of 0.2 to 6 parts by weight (all parts by weight based on 100 parts by weight of polyol or polyol component), more preferably in an amount of 1.5 to 5.0 parts by weight. Together with or in place of water it is also possible to use physical blowing agents, for example carbon dioxide, acetone, hydrocarbons, such as n-, iso- or cyclopentane, cyclohexane or halogenated hydrocarbons, such as methylene chloride, tetrafluoroethane, pentafluoropropane, heptafluoropropane, pentafluorobutane, hexafluorobutane or dichloromonofluoroethane. The amount of physical blowing agent is preferably in the range between 1 to 15 parts by weight, especially 1 to 10 parts by weight, and the amount of water is preferably in the range between 0.5 to 10 parts by weight, especially 1 to 5 parts by weight based on 100 parts by weight of polyol or polyol component. Carbon dioxide is preferred among the physical blowing agents, and is more preferably used in combination of water as chemical blowing agent. The process for producing polyurethane foam according to the present invention preferably does not use any halogenated hydrocarbons as (physical) blowing agents.

Optional Additives By way of further, optional additives the reaction mixture may include for example flame retardants, preferably flame retardants which are liquid and/or soluble in one or more of the components used for polyurethane foam production. It is preferable to use commercially available phosphorus-containing flame retardants, for example tricresyl phosphate, tris(2-chloroethyl) phosphate, tris(2-chloropropyl) phosphate, tris(2,3-dibromopropyl) phosphate, tris-1,3-dichloropropyl) phosphate, tetrakis(2-chloroethyl) ethylene diphosphate, trisbutoxyethyl phosphate, dimethyl methanephosphonate, diethyl ethanephosphonate, diethyl diethanolaminomethylphosphonate. Also suitable are halogen- and/or phosphorus-containing flame-retardant polyols and/or melamine. Flame retardants are preferably used in an amount of not more than 35 wt %, preferably not more than 20 wt %, based on the polyol component.

Further examples of optional additives include for instance surface-active admixtures and foam stabilizers and also cell regulators, reaction retardants, stabilizers, flame-inhibiting substances, dyes and also fungistats and bacteriostats. Details of how to use these admixture agents and how they act are described in G. Oertel, Polyurethane Handbook, 2nd edition, Hanser/Gardner Publications Inc., Cincinnati, Ohio, 1994, p. 55-127.

The process for producing polyurethane foam wherein the disalt of malic acid is used according to the invention can be carried out on low-pressure or on high-pressure machines for example. Technical design forms for such machines are discernible from the literature: G. Oertel, Polyurethane Handbook, 2nd edition, Hanser/Gardner Publications Inc., Cincinnati, Ohio, 1994, p. 129-171 and 178-186.

The disalt of malic acid can be added to the reaction mixture separately into the mixing chamber/head for example. But the disalt of malic acid can also be admixed upstream of the mixing chamber/head by being added to one of the components subsequently supplied to the mixing chamber. Admixing can already take place in the storage vessel of the raw materials, especially the polyol component. When the polyurethane foam is produced from high-pressure machines, the disalt of malic acid or a solution thereof is preferably added directly into the mixing head.

The polyurethane foam, especially the hot-cure flexible polyurethane foam, to be obtained by adding the disalt of malic acid can be produced in a continuous process or else in a batch process. Production preferably takes the form of a continuous process.

The foaming process involved in producing the polyurethane foam may be effected both horizontally and vertically. Foaming may also be effected directly in moulds.

The invention polyurethane foam having a glass transition temperature of −20° C. to +15° C. is characterized in that the polyurethane foam comprises disalts of malic acid or reaction products thereof with an isocyanate component, wherein the fraction accounted for by the disalts and the reaction products thereof with an isocyanate component is below 0.08 wt % based on the polyurethane foam.

Preferably, the polyurethane foam according to the invention is a viscoelastic polyurethane foam or a hot-cure flexible polyurethane foam, especially a hot-cure flexible polyurethane foam based on polyether polyols.

The polyurethane foam according to the invention preferably has a rebound resilience as measured in the falling ball test of DIN EN ISO 8307 of below 10% and preferably in the range from 0.5 to 7.5%.

The gas permeability of the polyurethane foam according to the invention, especially the hot-cure flexible polyurethane foam, is preferably in the range from 1 to 300 mm water column, preferably 7 to 25 mm water column in line with DIN ISO 4638 (as measured by measuring the pressure differential on flow through a sample of the foam. A foam disc 5 cm in thickness is placed for this on a smooth support. A 10 cm×10 cm plate 800 g in weight and having a drill-hole 2 cm in diameter in the middle and a hose connector is placed on the sample of foam. A constant 8 Vmin flow of air is passed into the sample of foam via the drill-hole in the middle. The pressure differential which arises (relative to unhindered outflow) is determined by means of a water column in a graduated manometer. The greater the closed-cell content of the foam, the greater the pressure which develops and the greater the degree to which the level of the water column is pushed down and the greater the values which are measured).

The polyurethane foam according to the invention may be a slabstock foam or a moulded foam.

The polyurethane foam according to the invention, especially the hot-cure flexible polyurethane foam preferably has a DIN 7726 pressure deformation resistance of less than 15 kPa (measured as per DIN 53421).

The polyurethane foam, especially hot-cure flexible polyurethane foam according to the invention has a 40% compression stress of 0.1 kPa to 5 kPa, preferably 0.5 to 2 kPa, determined as per DIN EN ISO3386-1/2.

The cell structure of the polyurethane foam, especially the hot-cure flexible polyurethane foam according to the invention is preferably more than 80% open-celled (measured as per DIN ISO 4590).

The density of the polyurethane foam, especially the hot-cure flexible polyurethane foam according to the invention is preferably in the range from 15 to 100 kg/m², more preferably in the range from 30 to 80 kg/m² and even more preferably in the range from 40 to 70 kg/m² (measured according to DIN EN ISO 845, DIN EN ISO 823).

The pore structure (average number of cells per 1 cm) in the polyurethane foam according to the invention is preferably in the range from 5 to 25 cells/cm and is determined by visual inspection of a cut face (measured as per DIN EN 15702).

Preferred polyurethane foams according to the invention have two or more of the abovementioned preferred parameters, preferably all the abovementioned parameters, within preferably the narrowest stated range.

Polyurethane foams which are in accordance with the present invention are useful in the manufacture of articles which are in accordance with the present invention. These articles of manufacture which are in accordance with the present invention include or contain polyurethane foams which are in accordance with the present invention. Corresponding articles of manufacture can be mattresses or pillows for example.

Further subjects and embodiments of the invention will become apparent from the claims, the disclosure content of which is fully part of the description.

The examples which follow describe the present invention by way of example without any intention to restrict the invention, the scope of which is apparent from the entire description and the claims, to the embodiments recited in the examples.

### EXAMPLES

### Testing

The performance tests were carried out using a typical formulation of a viscoelastic polyurethane foam, the composition of which is as follows:
30 parts by weight of Voranol® CP 3322 polyol (commercial polyol from DOW)
70 parts by weight of Voranol® CP 755 polyol (commercial polyol from DOW)
7 parts by weight of Voranol® CP 1421 polyol (commercial polyol from DOW)
1.95 parts by weight of water
0.2 part by weight of TEGOAMIN® BDE (bis(dimethylaminoethyl) ether solution, amine catalyst from EVONIK Industries AG)
0.3 part by weight of TEGOAMIN® 33 (triethylenediamine solution, amine catalyst from EVONIK Industries AG)
0.2 part by weight of TEGOAMIN® DMEA (dimethylethanolamine solution, amine catalyst from EVONIK Industries AG)
0.07 part by weight of KOSMOS® 29 (tin(II) 2-ethylhexanoate, tin catalyst from EVONIK Industries AG)
a varying amount (from 0 to 0.5 part by weight) of the in-test additives for shifting the glass transition temperature, using the inventive disodium malate and propylene glycol, n-butanol, glycerol, sodium lactate, sodium citrate, sodium tartrate, sodium succinate, sodium malonate and sodium acetate as non-inventive additives,
0.1 part by weight of ORTEGOL® 76 (cell-opener from EVONIK Industries AG)
1.1 parts by weight of TEGOSTAB® BF 2470 (foam stabilizer from EVONIK Industries AG)
40.3 parts by weight of tolylene diisocyanate (TDI 80) (for an index of 85, correspondingly higher quantities for an index of 90 or 95).

### Test Procedure for Foam Stabilizers to be Tested:

The tin catalyst tin(II) 2-ethylhexanoate, the three polyols, the water, the three amine catalysts and, if used, the additive for shifting the glass transition temperature were used as initial charge in a paper cup and mixed for 60 s at 1000 rpm, using a disc stirrer. The isocyanate was then added and incorporated for 7 s at 1500 rpm, using the same stirrer. The mixture in the cup began to foam up in the process. It was therefore poured into a foaming box directly after stirring had ended. The foaming box has a base area of 17×17 cm and a height of 30 cm. External PU foam insulation 5 cm in thickness prevented excessively rapid cooling. On its inside, the box had a lining of plastics film to permit subsequent removal of the fully cured foam. The foam grew once the material had been poured into the foaming box. Ideally, gas pressure in the foam reduces once the maximum rise height has been reached, and the foam then relaxes slightly. The cell membrane of the foam bubbles opened there, and an open-pore cell structure was obtained in the foam. In the event of an insufficient stabilizing effect, the PU foam collapsed before reaching the maximum height of rise. In the event of excessive stabilization, rise of the foam was very prolonged, and gas pressure in the foam did not reduce. Because the cell structure was then very closed, contraction in volume of the gas as it cooled caused shrinkage of the foam.

### Observations:

The foam grew, and gas pressure in the foam reduced after about 2 min, and no alteration occurred in the foam during subsequent cooling. Subsequent measurement gave cell number as 7 cells/cm and porosity as 180 to 290 mm (measurement of backpressure, by determining the height of a water column generating an equivalent pressure). This shows that the cell structure is sufficiently fine and open (the term closed foams being used for a water column of about 300 mm or more). The foam had the desired viscoelastic properties. A sample was taken from the centre of the cured flexible foam after 3 days to measure the DSC curve. For this, 15-25 mg of the flexible foam are pressed into a metal crucible and the DSC curve is measured at from −70 to 100° C. at a heating rate of 10° C./min. Heat flow into the sample was determined and plotted in graph form. The 1^{st} heating curve was used for analysis. The inflexion point of glass transition was determined therein. The related temperature was deemed to be the glass transition temperature.

The results of foaming the reaction products are reported below in Tables 1 to 3.

The foams of Table 1 were produced without using an additive to shift the glass transition temperature.

TABLE 1
Effect of ratio of isocyanate groups to isocyanate-consuming
groups (index) on foaming properties

| | | | | | Compression | |
|---|---|---|---|---|---|---|
| | Rise | Rise | | | hardness | |
| Index | time | height | Settling | Porosity | (CLD 40%) | GT* |
| [ ] | [s] | [cm] | [cm] | [mm] | [kPa] | [° C.] |
| 80 | 167 | 33.8 | −0.3 | 200 | 0.6 | −17.0 |
| 85 | 151 | 34.4 | −0.5 | 250 | 0.8 | −13.2 |
| 90 | 135 | 35.5 | −0.5 | 250 | 1.3 | −6.9 |
| 95 | 122 | 36.4 | −0.8 | 290 | 2.3 | −1.6 |

*GT = glass transition temperature

As can be seen in Table 1, the glass transition temperature rises as the index increases, but at the same time the rise times and also the foam properties, especially the compression hardnesses change.

Table 2 reports the use quantities and results for the comparative foams produced using non-inventive additives. An index of 85 was used in each case.

TABLE 2
Effect of comparative substances on foaming properties

| | | | | | | Compression | |
|---|---|---|---|---|---|---|---|
| | Use | Rise | Rise | | | hardness | |
| | quantity | time | height | Settling | Porosity | (CLD 40%) | |
| Additive [ ] | [**] | [s] | [cm] | [cm] | [mm] | [kPa] | GT [° C.] |
| Reference | 0 | 151 | 34.4 | −0.5 | 250 | 0.8 | −13.2 |
| Propylene glycol | 0.1 | 152 | 34.8 | −0.4 | 263 | 0.8 | −13.3 |
| Propylene glycol | 0.5 | 147 | 35.2 | −0.3 | 280 | 0.9 | −13.5 |
| n-Butanol | 0.1 | 149 | 34.9 | −0.5 | 247 | 0.75 | −13.5 |
| n-Butanol | 0.5 | 145 | 34.8 | −0.2 | 240 | 0.7 | −14.3 |
| Glycerol | 0.1 | 147 | 34.6 | −0.4 | 256 | 0.85 | −13 |
| Glycerol | 0.5 | 138 | 35 | −0.3 | 290 | 1.05 | −12.3 |
| Sodium lactate | 0.1 | 152 | 35.9 | −0.1 | 220 | 0.8 | −14.4 |
| Sodium lactate | 0.5 | 149 | 35.7 | −0.1 | 286 | 0.75 | −15 |
| Sodium citrate | 0.1 | 149 | 34 | −0.1 | 236 | 0.75 | −8.7 |
| Sodium citrate | 0.5 | 193 | 33.3 | −0.2 | 241 | 0.65 | −7.5 |
| Sodium tartrate | 0.1 | 181 | 34.5 | −0.2 | 254 | 0.7 | −9.9 |
| Sodium tartrate | 0.5 | 181 | 34.6 | −0.2 | 189 | 0.7 | -9.7 |
| Sodium succinate | 0.1 | 136 | 34.6 | 0 | 291 | 0.8 | −13 |
| Sodium succinate | 0.5 | 126 | 35 | 0 | 300 | 0.9 | −13.5 |
| Sodium malonate | 0.1 | 135 | 34.8 | −0.1 | 267 | 0.75 | −11.7 |
| Sodium malonate | 0.5 | 145 | 35.4 | −0.1 | 289 | 0.7 | −10.4 |
| Sodium acetate | 0.1 | 125 | 34.8 | −0.2 | 290 | 0.8 | −13.5 |
| Sodium acetate | 0.5 | 45 | 34 | −0.2 | 300 | 0.9 | −13.6 |

** in parts by mass per 100 parts of polyol

As is readily apparent from Table 2, the use of non-inventive additives has little or no effect on the glass transition temperature, or the glass transition temperature rises. No additives effecting any significant lowering in the glass transition temperature were identified.

Table 3 reports the use levels and results of the inventive foams produced which used disodium malate. Again an index of 85 was used in each case.

TABLE 3
Influence of disodium malate on foaming properties

| Amount of | | | | | | |
|---|---|---|---|---|---|---|
| disodium | | | | | | |
| malate used | | | | | Compression | |
| [parts by mass | Rise | Rise | | | hardness | |
| per 100 parts | time | height | Settling | Porosity | (CLD 40%) | GT |
| of polyol] | [s] | [cm] | [cm] | [mm] | [kPa] | [° C.] |
| 0 | 151 | 34.4 | −0.5 | 250 | 0.8 | −13.2 |
| 0.04 | 155 | 34.9 | −0.4 | 233 | 0.6 | −15.9 |
| 0.08 | 153 | 34.8 | −0.3 | 186 | 0.6 | −17.4 |
| 0.12 | 154 | 34.9 | −0.3 | 205 | 0.6 | −18.7 |

As is discernible in Table 3, the inventive use of disodium malate leads to an appreciable lowering in glass transition temperature without any significant effect on other foam properties, especially the compression hardness being observed. Rise time remains essentially unchanged on adding disodium malate. The porosity value decreases slightly, which indicates a slightly higher air permeability. This can be deemed to be advantageous for use in mattresses and pillows.

1. A method to lower glass transition temperature of a polyurethane foam, said method comprising:
adding a disalt of malic acid to a reaction mixture comprising at least a polyol component, an isocyanate component, and a catalyst to catalyze urethane or isocyanurate bond formation.

2. The method according to claim 1, wherein said disalt of malic acid is added in a concentration of above 0 to below 0.1 part by mass per 100 parts by mass of polyol component.

3. The method according to claim 1, wherein said disalt of malic acid is a disodium salt of malic acid.

4. The method according to claim 1, wherein said disalt of malic acid is a disalt of L-hydroxysuccinic acid.

5. The method according to claim 1, wherein said disalt of malic acid is added to said reaction mixture as a 5 to 25 wt % solution of said disalt of malic acid in at least one of water, dipropylene glycol, propylene glycol, butyldiglycol, ethanol, isopropanol, ethylene glycol, diethylene glycol, polyether, and polyol.

6. The method according to claim 1, wherein said disalt of malic acid is used as 1 to 50 wt % solution of said disalt of malic acid in a mixture comprising water and dipropylene glycol in a mass ratio of 0.5:1 to 1:0.5.

7. A polyurethane foam having a glass transition temperature of −20° C. to 15° C., wherein said polyurethane foam comprises disalts of malic acid or reaction products thereof with an isocyanate component, wherein the fraction accounted for by said disalts of malic acid and said reaction products thereof with an isocyanate component is below 0.08 wt % based on said polyurethane foam.

8. The polyurethane foam according to claim 7, wherein said polyurethane foam is a viscoelastic polyurethane foam.

9. The polyurethane P foam according to claim 7, wherein said polyurethane foam has a rebound resilience of below 10%.

10. An article of manufacture comprising a polyurethane foam having a glass transition temperature of −20° C. to 15° C., wherein said polyurethane foam comprises disalts of malic acid or reaction products thereof with an isocyanate component, wherein the fraction accounted for by said disalts of malic acid and said reaction products thereof with an isocyanate component is below 0.08 wt % based on said polyurethane foam.

11. The article of manufacture according to claim 10, wherein said article of manufacture is a mattress or pillow is concerned.

12. The article of manufacture according to claim 10, wherein said article of manufacture is a pillow.

13. The article of manufacture according to claim 10, wherein said polyurethane foam is a viscoelastic polyurethane foam.

14. The article of manufacture according to claim 10, wherein said polyurethane foam has a rebound resilience of below 10%.
